(19) United States
(12) Patent Application Publication
(10) Pub. No.: US 2017/0111418 A1
(43) Pub. Date: Apr. 20, 2017

(54) TWO-WAY INTERACTIVE STREAMING MEDIA

(71) Applicant: Microsoft Technology Licensing, LLC, Redmond, WA (US)

(72) Inventors: Bruce F.M. Warren, Issaqua, WA (US); Jacqueline Nicole Montplaisir, Sammamish, WA (US); Karlo Reyes, Bothell, WA (US); Corey Harrison Smith, Bellevue, WA (US); Daniel Brunner, Sammamish, WA (US); Richard Jonathon Charles Winn, Carnation, WA (US); Kenneth Wayne Smith, Tacoma, WA (US); Derrick Vaughan Houger, Monroe, WA (US); Nicholas Jordan Holman, Seattle, WA (US); Matthew Agee McMillan, Kailua, HI (US); Mary Gov, Redmond, WA (US)

(73) Assignee: Microsoft Technology Licensing, LLC, Redmond, WA (US)

(21) Appl. No.: 15/001,051

(22) Filed: Jan. 19, 2016

Related U.S. Application Data
(60) Provisional application No. 62/242,757, filed on Oct. 16, 2015.

(51) Int. Cl. H04L 29/06; H04N 21/643; H04N 21/472; G06F 17/30; H04N 21/431; H04N 21/8549; G06F 3/0482; H04N 21/858; H04L 29/08

(52) U.S. Cl. CPC H04L 65/60; H04N 21/8586; H04N 21/64322; H04N 21/47202; H04L 67/02; H04N 21/4316; H04N 21/8549; G06F 3/0482; G06F 17/30887; G06F 17/3089

(57) ABSTRACT

Technologies are described for providing a two-way interactive streaming media experience. For example, streaming media comprising streaming video can be received along with overlay control data and a web overlay. The web overlay can be composited on top of the streaming video according to timing information in the overlay control data. Users can interact with the web overlay (e.g., select buttons or perform other actions). Indications of user interactions can be provided to a server environment and updated streaming media, new web overlays, and/or new web content can be received as a result.

### BACKGROUND

Video content is being provided over the Internet with increasing frequency. For example, video on demand services allow users to view streaming video content using their computers, smart phones, and other types of computing devices. In addition, live video broadcasts can be provided as streaming video over the Internet. However, providing interactive content in combination with such streaming video content can be difficult or impossible.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Technologies are described for providing a two-way interactive streaming media experience. In some implementations, interactive television is used for delivering timed interactive layers over live and on-demand video feeds.

For example, streaming media comprising streaming video can be received along with overlay control data and a web overlay. The web overlay can be composited on top of the streaming video according to timing information in the overlay control data. Users can interact with the web overlay (e.g., select buttons or perform other actions). Indications of user interactions can be provided to a server environment and updated streaming media, new web overlays, and/or new web content can be received and provided for display in response to the interaction.

### BRIEF DESCRIPTION OF THE DRAWINGS

FIG. 1 is a diagram depicting an example environment supporting two-way interaction with live composited web overlays over streaming video content.

FIG. 2 is a diagram depicting example composited streaming media content with a live composited web overlay supporting two-way interaction.

FIG. 3 is a diagram depicting example composited streaming media content with a live composited web overlay including polling results and supporting two-way interaction.

FIGS. 4A and 4B are diagrams depicting examples of targeted web overlays displayed in response to two-way interaction.

FIGS. 5A, 5B, and 5C are diagrams depicting an example of two-way interaction during a live awards show event.

FIG. 6 is a flowchart of an example method supporting two-way interaction with a web overlay for providing updated streaming media.

FIG. 7 is a flowchart of an example method supporting two-way interaction with a web overlay.

FIG. 8 is a diagram depicting an example polling solution architecture comprising a polling admin tool, a JSON writer endpoint, and a statistics aggregation web farm.

FIG. 9 is a diagram of an example computing system in which some described embodiments can be implemented.

### DETAILED DESCRIPTION

### Overview

As described herein, various technologies are provided supporting two-way interaction with streaming media (e.g., providing an interactive two-way television (TV) experience). In some implementations, interactive television is used for delivering timed interactive layers over live and on-demand video feeds. For example, the timed interactive layers can be provided over Internet protocol television (IPTV) live and on-demand video feeds (e.g., streaming media content comprising video and audio). Various technologies described herein make it possible for viewers to interact with streaming media broadcasts in new and meaningful ways. For example, users can interact with web overlays composted on top of streaming video. In response to the interaction, the users can receive updated streaming media, new web overlays, and/or new web content.

In the live events space this capability expands user interactivity within a streaming media broadcast, such as an IPTV broadcast. For example, using the technologies described herein, users can interact with live streaming media (e.g., live IPTV streaming media) in the following forms:
Live polling
Commerce
Games over live IP video
Expanding narratives during live IP TV that enriches the user journey
Video on demand (VOD) and live video experiences
Regional customization making the experience relevant to a global audience

### Example Components and Operations for Live Compositing of Web Overlays Over Streaming Media

In the technologies described herein, components and operations are provided supporting live compositing of web overlays over streaming media content (e.g., video content or video and audio content). For example, the components and operations can be performed by a server environment (e.g., media processing devices, streaming media servers, database servers, content delivery networks, video and audio coding systems, networking devices, etc.) and/or a client-side environment (e.g., one or more computing devices performing operations for receiving streaming media, compositing web overlays, managing real-time interactions, etc.).

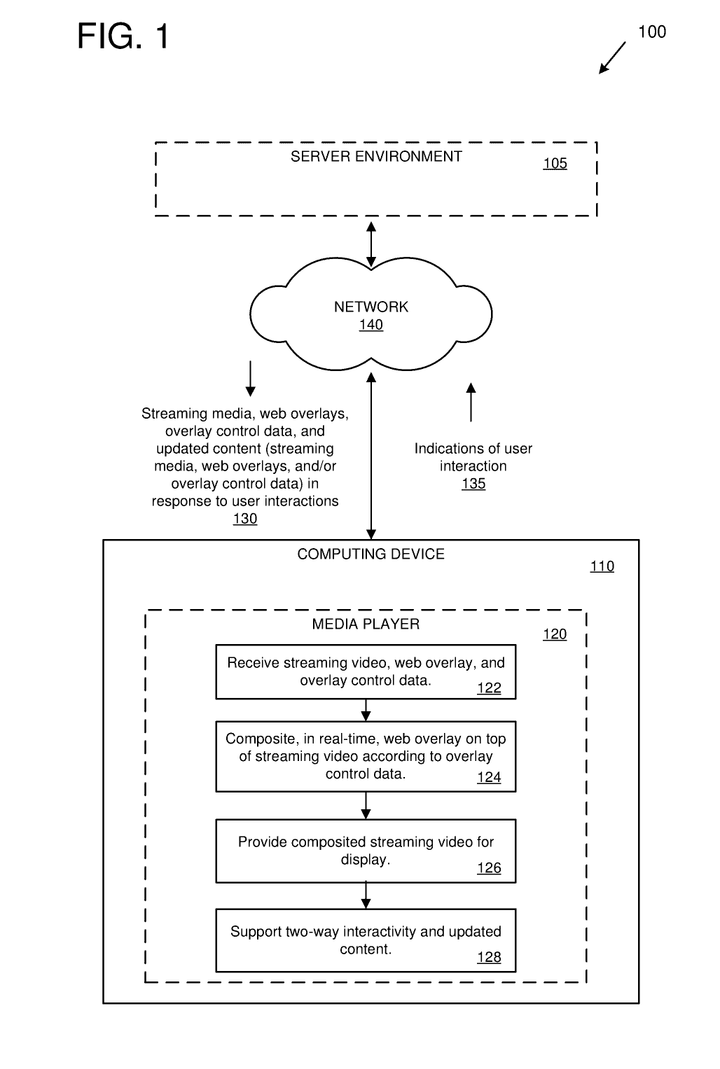

FIG. 1 is a diagram depicting an example environment 100 supporting live compositing of web overlays over streaming media content. In the example environment 100, a network 140 provides data connectivity to one or more computing devices, including computing device 110. The data connectivity is provided via an Internet protocol (IP) network connection.

The computing device 110 can be a gaming console, a set-top box, a tablet, a laptop, a smart phone, a desktop computer, or another type of computing device. The computing device 110 comprises hardware and/or software configured to perform operations for live compositing of web overlays over streaming media and for two-way interactivity. For example, the operations can be performed by a media player 120.

In some implementations, the computing device 110 receives streaming media, web overlays, and overlay control data, as depicted at 130. The streaming media can be received in an Internet protocol television (IPTV) format and/or in another streaming protocol delivered over the IP network. Example streaming protocols include HTTP Live Streaming (HLS), Dynamic Adaptive Streaming over HTTP (DASH, also called MPEG-DASH), HTTP Dynamic Streaming (HDS), MP4, and Smooth Streaming. The streaming media can be live media (e.g., a live video and audio stream of an awards show or event) and/or on-demand media (e.g., an on-demand video and audio stream that was previously recorded).

The web overlay can be an HTML (e.g., HTML5 or another HTML version) web overlay or another type of web control (e.g., a chromeless web browser window) that operates as an interactive layer (e.g., a transparent web layer) over the streaming video portion of the media content. The web overlay can comprise static and/or dynamic (e.g., interactive) content that is displayed within the web overlay (e.g., graphical elements, text, buttons, etc.). In some implementations, the web overlay is a web page comprising HyperText Markup Language (HTML), cascading style sheets (CSS), JavaScript, jQuery, JavaScript Object Notation (JSON) and/or other web page data. The web page can have a transparent background to facilitate compositing over the video content. In some implementations, the web overlay is provided in a single file comprising HTML, CSS, JavaScript, jQuery, JSON, and/or other web content. In some implementations, the web overlay is provided in a plurality of files and/or via a plurality of data streams.

The overlay control data comprises instructions and/or other data to control operation of the web overlay (e.g., timing information indicating when the web overlay will be displayed, removed, etc. in relation to timing markers, such as ticks or timestamps, within the streaming video), information to be included in the web overlay (e.g., references to text, graphics, static and/or dynamic content, user interface controls such as buttons, etc.), and/or interaction instructions (e.g., defining what happens when a viewer clicks on a button, etc.). The overlay control data can be provided in a data format such as JSON or XML. In some implementations, the streaming video, web overlays, and overlay control data are received via HTTP over the IP network connection.

In some implementations, the overlay control data comprises indications of one or more web overlays along with associated timing information. Below is a simplified example of overlay control data defining two web overlays (identified by overlay identifiers 515 and 516) and associated timing information:

```
{ OverlayId: 515
  Link: https://ConfigHost.com/overlay515content.html }
{ OverlayId: 516
  Link: https://ConfigHost.com/overlay516content.html }
{ TriggerId: 2630
  OverlayId: 515
  isOverlayOn: true
  TriggerTimeTicks: 300000000
  Animation: slideUp, 1 second }
{ TriggerId: 2631
  OverlayId: 515
  isOverlayOn: false
  TriggerTimeTicks: 400000000
  Animation: fade, 1 second }
```

The above simplified overlay control data defines two overlays, identified by overlay identifiers 515 and 516. Each overlay is associated with a link for obtaining its overlay data (e.g., OverlayId 515 obtains its overlay data from https://ConfigHost.com/overlay516content.html). In addition, two trigger events are defined, identified by trigger identifiers 2630 and 2631, which both control operation of overlay 515. Trigger 2630 defines when overlay 515 will appear as an overlay on streaming media. Specifically, overlay 515 will appear at 30 seconds (300000000 ticks) into the media stream and overlay 515 will have a slide up transition over a 1 second duration. Trigger 2631 defines when overlay 515 will be removed from being displayed on top of the streaming media. Specifically, overlay 515 will be removed at 40 seconds into the media stream and overlay 515 will have a fade out transition over a 1 second duration. Therefore, overlay 515 will be displayed for a duration of 10 seconds (from 30 seconds to 40 seconds according to timing information of the media stream). Additional triggers can be defined in the overlay control data (e.g., triggers for overlay 516, additional triggers for overlay 515, and/or triggers related to other overlays). Additional overlays can also be defined in the overlay control data.

In some implementations, additional timing information is provided within the web overlay itself. For example, a first set of timing information can be provided in the overlay control data for controlling timing of web overlays (when the web overlays are displayed and removed from display, how the web overlays transition to being displayed and removed from display, etc.). A second set of timing information can be provided within the web overlay that controls timing of events within the web overlay. For example, the display of text, buttons, and other elements can be controlled within the web overlay using the second set of timing information.

When the user viewing the streaming media interacts with the composited streaming video (e.g., selects a polling button within the web overlay), an indication of the interaction can be sent via the network 140, as depicted at 135. For example, the indication of the interaction can be sent to server environment 105 that in turn initiates sending of updated streaming media, web overlays, and/or overlay control data (as depicted at 130) for display at the computing device 110. For example, the interaction can result in updated content being displayed in the web overlay as the result of the user viewing the composited streaming video and selecting a graphical button during a polling event presented within the web overlay.

For example, the media player 120 can perform operations for live compositing of the web overlay over the streaming video. At 122, streaming video, a web overlay, and overlay control data are received. At 124, real-time compositing is performed to composite the web overlay on top of the streaming video according to the overlay control data. At 126, the composited streaming video is provided for display to a user (e.g., on an integrated display, on an attached display such as a television connected to a console device, or on a remote display). At 128, two-way interactivity and updated content are supported. For example, the media player 120 can receive a user interaction (e.g., a button press, a voice command to select a user interface element or displayed option, etc.), send an indication of the user interaction to the server environment 105 (e.g., as depicted at 135), and receive updated content in return for display by the media player 120 (e.g., new streaming media, a new web overlay, and/or new web content for display in an existing web overlay).

The technologies described herein can be used to provide streaming media (comprising streaming video), web overlays, and overlay control data to many destination computing devices at the same time. For example, a live broadcast (e.g., at an electronics convention) can be delivered over the Internet, as live streaming media, to many client devices. Interactive content can be synchronized with the live streaming media in real-time (e.g., comprising web overlays and overlay control data) and delivered along with the live streaming media. In some implementations, synchronization is provided in a live environment where an operator is viewing live streaming media (e.g., an awards show, a sporting event, and/or other live streaming media content) and controls when a given web overlay will be displayed (e.g., selects an option to time display of a web overlay to the announcement of a winner of an award category).

The client devices can receive the live streaming media, web overlays, and overlay control data, composite the web overlays on top of the live streaming video according to the overlay control data (e.g., controlling timing, synchronization, and interactivity), and present the composited live streaming video for display to a user with two-way interactivity supported via the web overlay. Each of the client devices may be receiving the live streaming video at slightly different times (e.g., due to network delays, buffering, time differences in content distribution networks, etc.). However, the client devices will all have the same experience because the web overlays will be timed to specific events (e.g., specific time codes) within the streaming video content. In some implementations, clients can view the streaming video later as video-on-demand

In some implementations, digital rights management (DRM) and/or tokenization features are applied to the streaming media, web overlays, web content, and/or overlay control data. For example, the path for obtaining a web overlay can be tokenized so that if a client tries to access the web overlay at a time before access has been authorized, the client will be denied access.

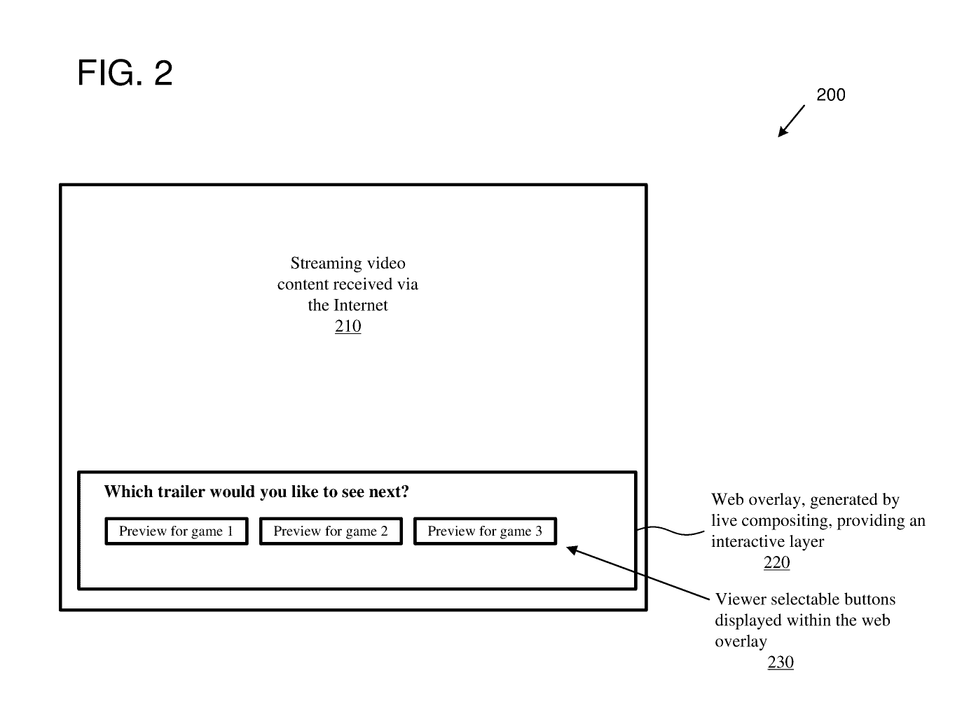

FIG. 2 is a diagram depicting an example presentation 200 of composited streaming media content with a live composited web overlay. For example, the presentation 200 can be displayed by a media player, such as media player 120.

As depicted, the streaming media comprises streaming video content 210 received via the Internet (e.g., live television content received via IPTV, video-on-demand content streamed using an Internet streaming protocol, or another type of streaming video content). The composited streaming video also comprises a web overlay 220, which provides a live interactive layer on top of the streaming video content 210. Also depicted is example web content that could be presented within the web overlay 220, which is a question asking the user viewing the presentation 200 which video game trailer the user would like to see next, along with three selectable buttons 230.

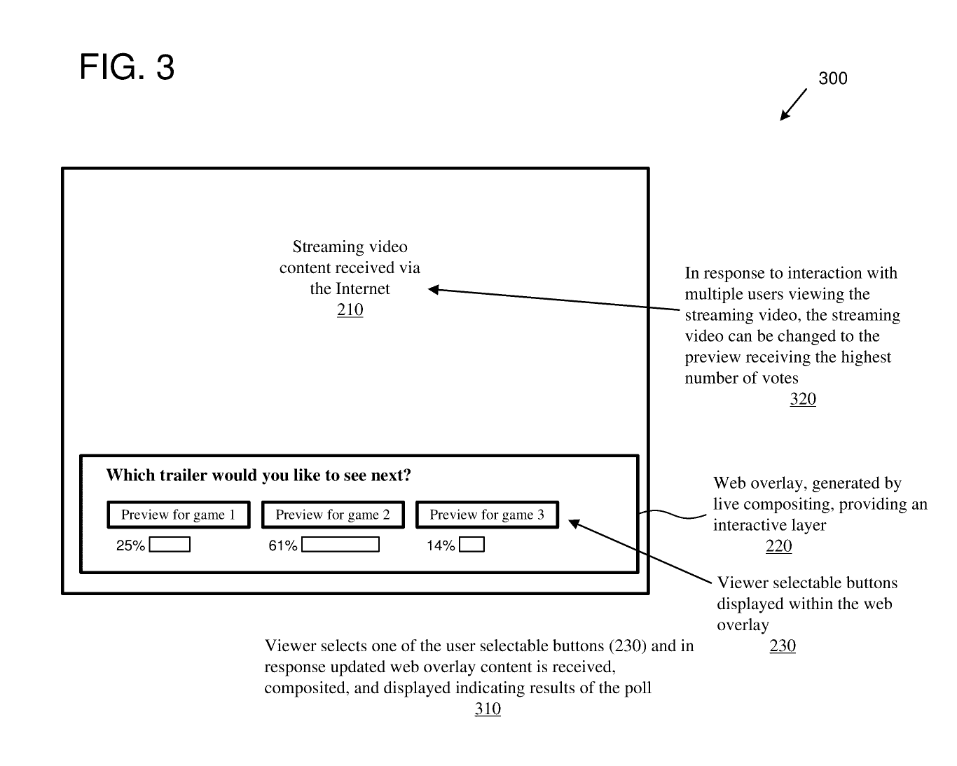

FIG. 3 is a diagram depicting an example updated presentation 300 in which the user has selected one of the selectable buttons 230 presented in FIG. 2. In some implementations, selecting the button initiates a message to a server environment (e.g., to server environment 105) to send an indication of the selection (e.g., comprising anonymized session information, which button was selected, etc.). In response, updated content can be received. In this example, the updated content includes updated web content for the web overlay which includes percentage results for the three possible next trailers, as depicted at 310. For example, the streaming video content 210 can be updated to stream the trailer that receives the highest percentage of votes by the users currently viewing the streaming video content (e.g., aggregate results from a number of viewers concurrently viewing the web overlay as a live interactive poll), as depicted at 320.

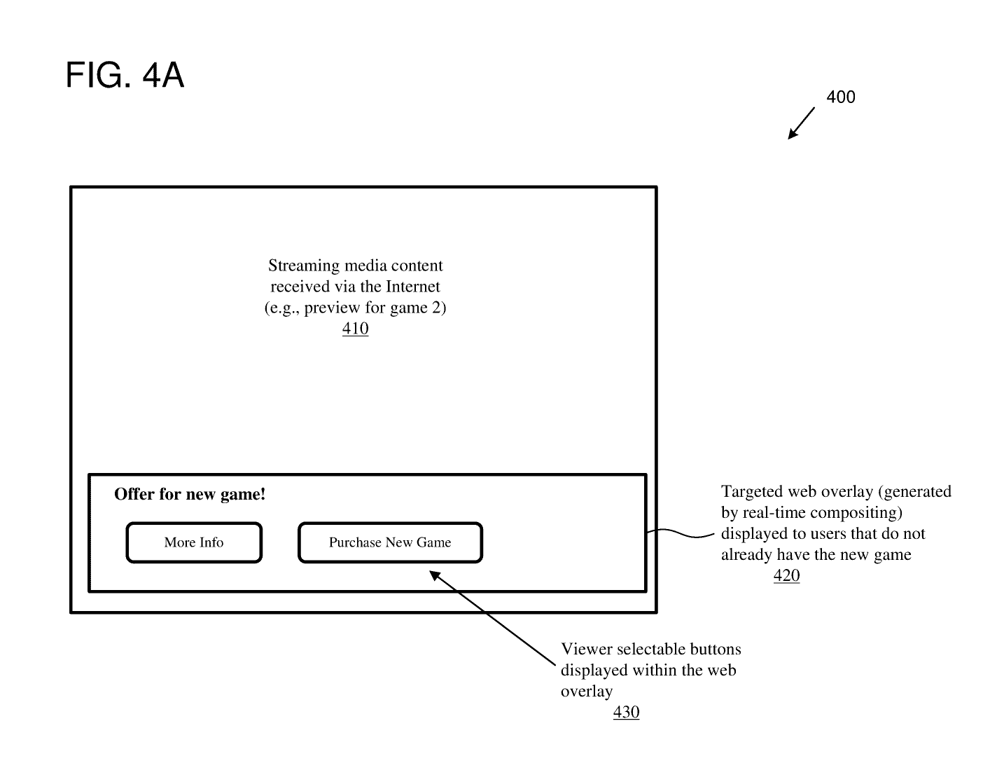

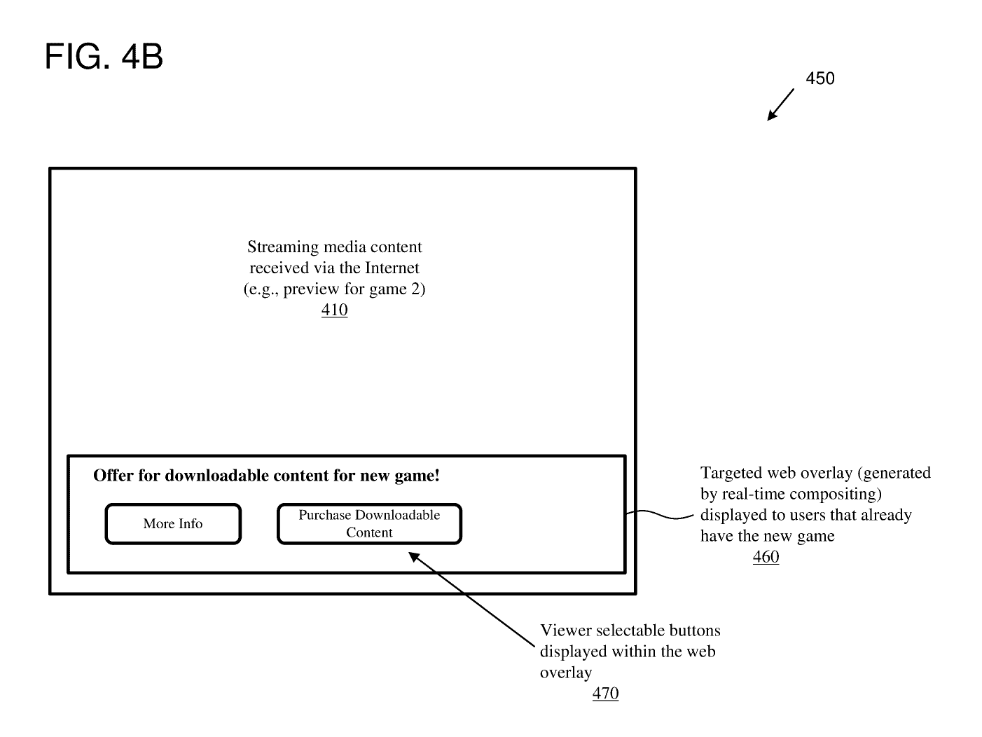

FIG. 4A is a diagram depicting an example presentation 400 of a targeted web overlay displayed in response to two-way interaction. For example, the streaming media content can be displayed in response to viewers voting to see a preview for game 2, as a continuation of presentation 300.

In the example presentation 400, a targeted web overlay 420 is displayed. The targeted web overlay 420 is presented to the user based on user attributes. For example, information associated with the user can be stored (e.g., locally and/or remotely, such as at a server environment). The information can describe attributes of the user that do not personally identify the user (e.g., content that the user has purchased, user viewing history, content consumption history, user interaction details with the web overlays, etc.). In some implementations, unique user identifiers are used to uniquely identify and target particular users and/or groups of users that have common attributes.

In the scenario depicted in the example presentation 400, the user is being presented with a targeted web overlay 420 in response to determining that the user does not already have a particular new game. For example, the determination can be made locally (e.g., by the user's computing device to select among a number of received web overlays or web content based on the user's attributes) or remotely (e.g., by a server environment that receives or stores user attributes and designates particular web overlays or web content for display to particular users and/or groups of users). In the targeted web overlay 420, web content is displayed including user interface elements for obtaining more information about the new game and purchasing the new game, as depicted at 430.

FIG. 4B is a diagram depicting an example presentation 450 of a targeted web overlay displayed in response to two-way interaction. The example presentation 450 illustrates how different targeted web overlays can be provided to viewers based on their specific attributes. Specifically, the example presentation 450 is provided for display to those users that already have the new game, as depicted in the targeted web overlay 460 and the web content 470 displayed within. For example, if a number of users are viewing the presentation 300, then those users who have the new game will see the example presentation 400 while those users that do not have the new game will see the example presentation 450. For example, both targeted web overlays 420 and 460 can be sent to all viewers and the decision can be made at the client device to present one or the other based on the user of a given client device.

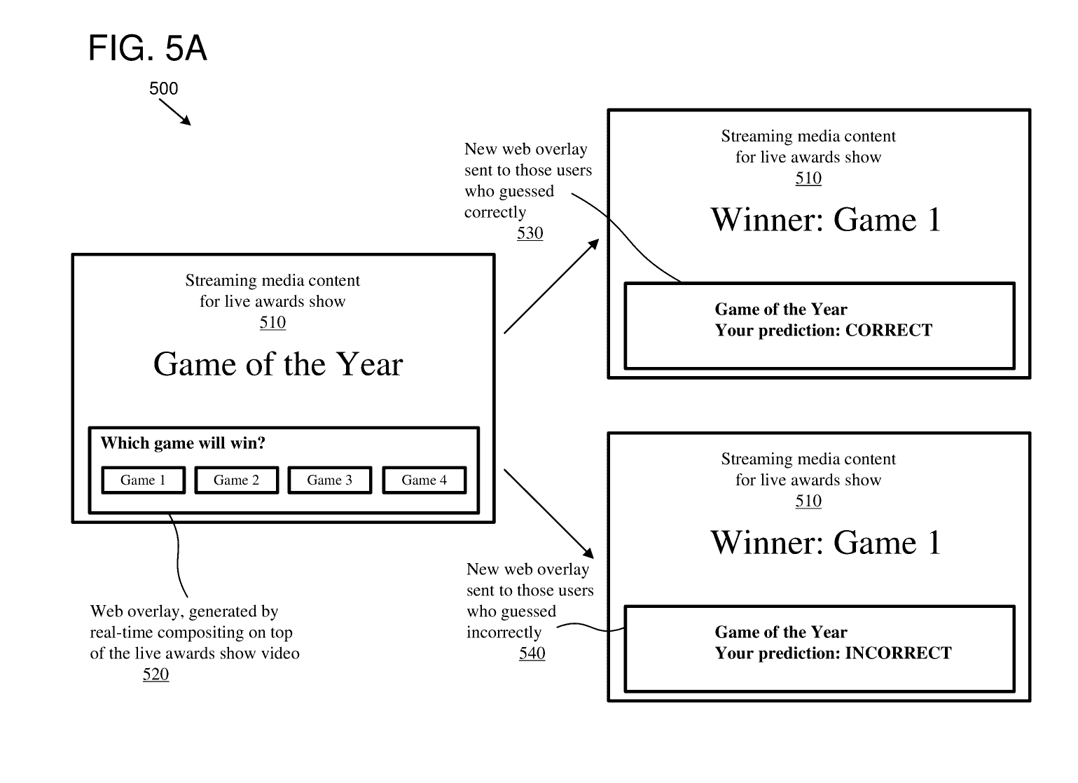

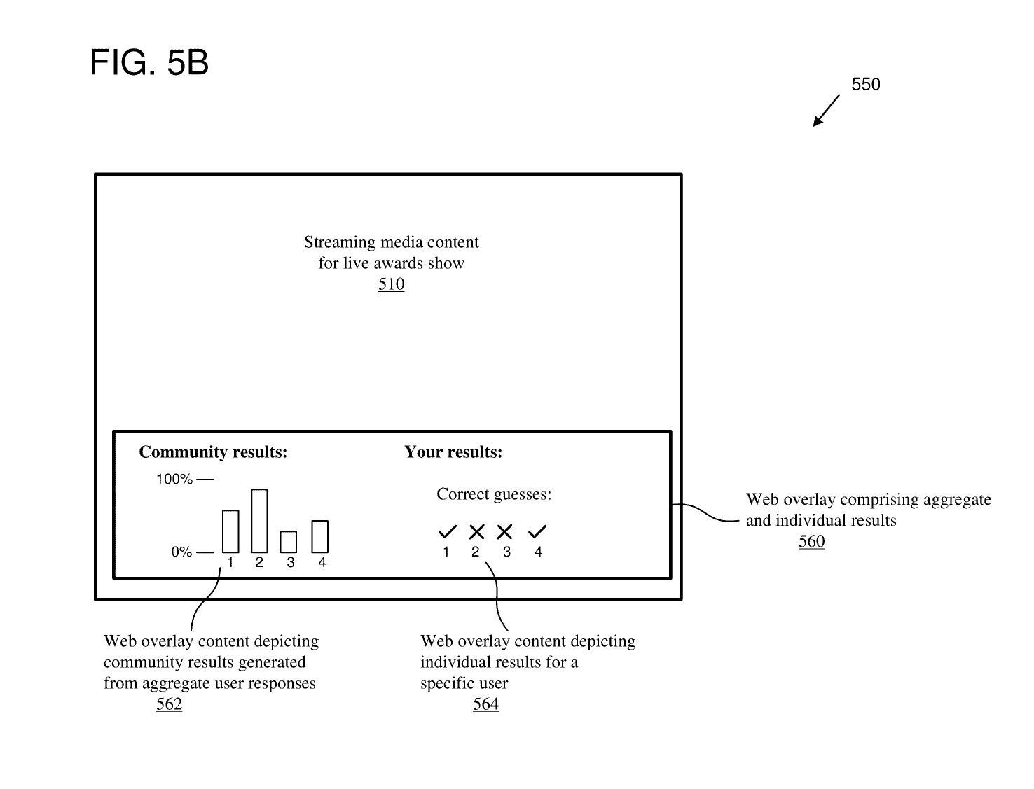

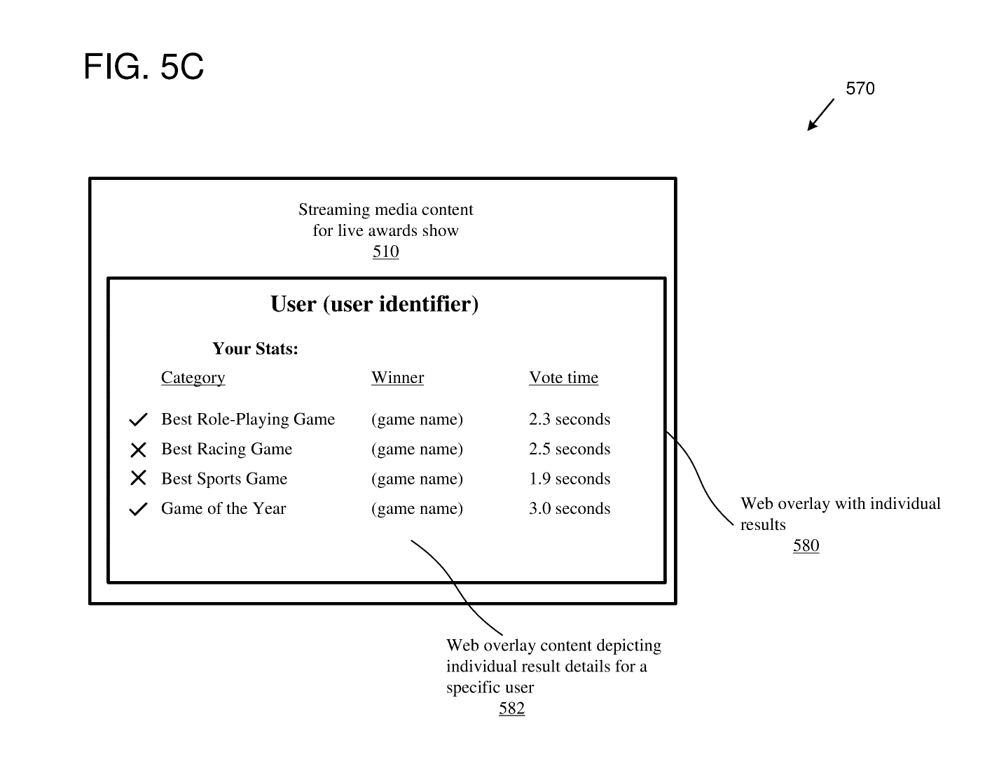

FIGS. 5A, 5B, and 5C are diagrams depicting an example of two-way interaction occurring during a live awards show event for video games. As depicted at 500, a number of users are viewing streaming media content for a live awards show 510. A web overlay 520 has been received and composited on top of the streaming video of the awards who, which is currently presenting the game of the year. The web overlay 520 contains web content (web overlay content) asking users to vote on which game they believe will win. For example, all users viewing the streaming media can be presented with the same web overlay 520. Once voting is done (e.g., based on a voting time window), users will be presented with one of the web overlays 530 or 540 depending on whether they voted correctly. For example, an indication of user interaction can be sent to a server environment for each user voting (in this scenario, the indication indicates which game the user voted for). The new web overlays 530 and 540 can then be received in response and one of them displayed depending on how the user voted.

FIG. 5B depicts a presentation 550 in which aggregate results and user-specific results are displayed. Specifically, web overlay 560 comprises aggregate results based on user interaction data generated from a plurality of users viewing the streaming media content 510 as well as individual results based on user interaction data generated from the specific user viewing the presentation 550. The aggregate results are depicted by the web overlay content 562 (aggregate results for voting on four different categories). The individual results are depicted by the web overlay content 564 (whether the specific user voted correctly or incorrectly for the four categories).

FIG. 5C depicts a presentation 570 in which individual result details are depicted in a larger size web overlay 580 (e.g., a full-screen or nearly full-screen web overlay). Specifically, the web overlay 580 contains web overlay content 582 depicting how the specific user performed during the voting, including whether the user voted correctly or incorrectly for each of four categories, the winner of each category, and how long it took the user to vote.

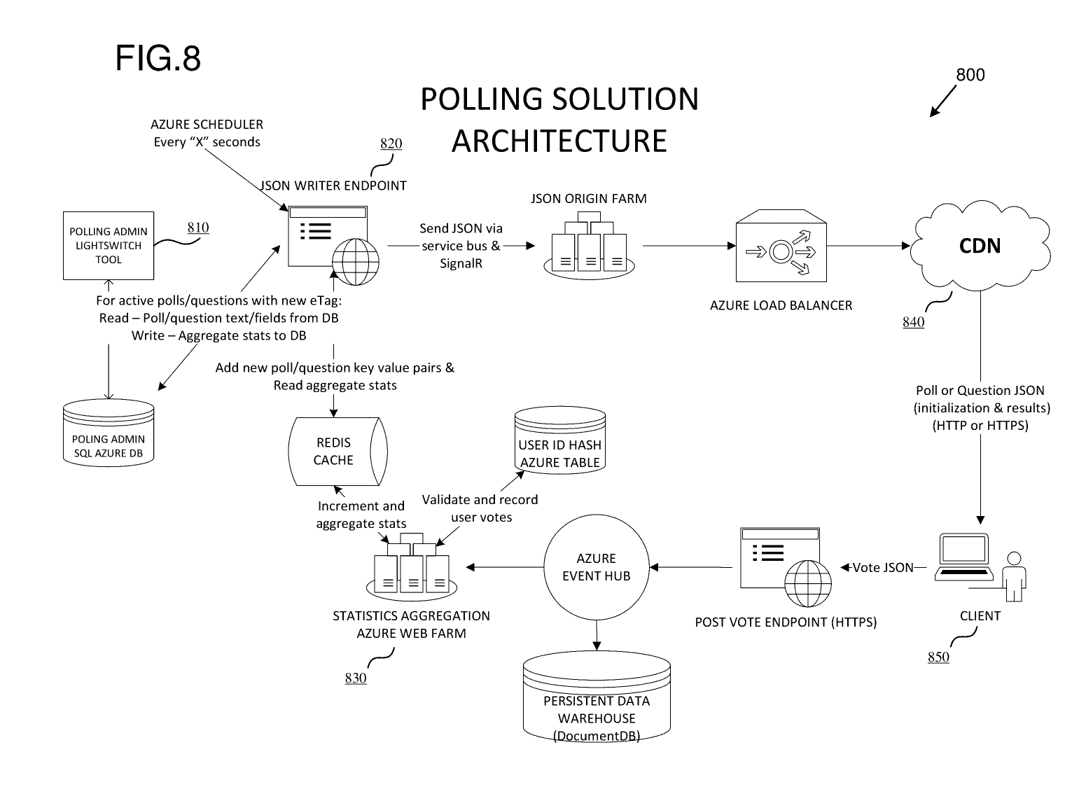

FIG. 8 is a diagram depicting an example polling solution architecture 800 comprising a polling admin tool 810, a JSON writer endpoint 820, and a statistics aggregation web farm 830. In the polling solution architecture 800, web overlays and overlay control data supporting the polling solution are provided to the clients (including client 850) via a content delivery network (CDN 840). Polling results from the clients (e.g., the indications of user interaction) are provided to the statistics aggregation web farm 830 for analysis, which can result in new and/or updated content (e.g., streaming media, web overlays, web content, and/or overlay control data) being delivered to the clients.

### Example Methods for Two-Way Interaction with Composited Web Overlays

In the technologies described herein, methods can be provided for two-way interaction with composited web overlays over streaming video. For example, a web overlay can be received and composited on top of streaming video at a client device (e.g., by a media player). The user can interact with the web overlay (e.g., select buttons). An indication of the interaction can be sent to a server environment. In response, updated content can be received and displayed to the user (e.g., updated streaming video, new web overlays, new overlay control data, and/or new web content for display in an existing web overlay).

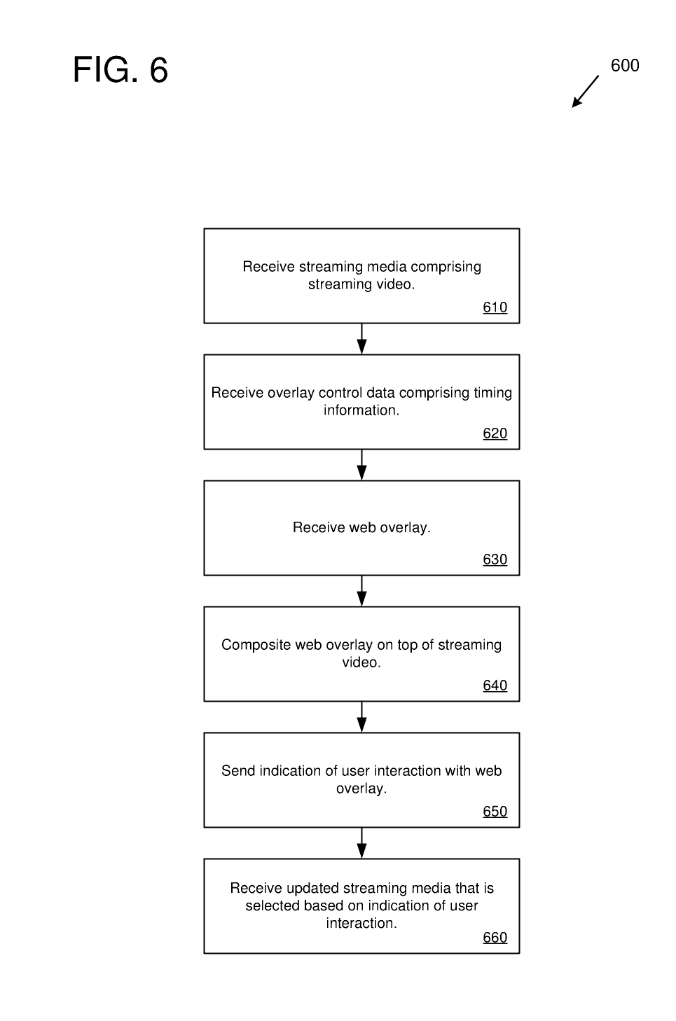

FIG. 6 is a flowchart of an example method 600 supporting two-way interaction with a web overlay for providing updated streaming media. For example, the example method 600 can be performed by a computing device running a media player, such as media player 120.

At 610, streaming media is received. The streaming media comprises streaming video, and can also comprise streaming audio.

At 620, overlay control data is received. The overlay control data comprises timing information for controlling display of a web overlay. The overlay control data can also comprise information describing the web overlay (e.g., a link for obtaining the web overlay).

At 630, the web overlay is received. For example, the web overlay can be obtained via a link within the overlay control data.

At 640, the web overlay is composited on top of the streaming video according to the overlay control data. For example, the timing information can specify a time at which to display the web overlay and a time at which to remove the web overlay from display. The timing information can be used to control other aspects of the web overlay as well, such as transitions (e.g., fade-in and fade-out of the web overlay).

At 650, an indication of user interaction with the web overlay is sent to a server environment (e.g., to server environment 105). For example, a user can interact with the web overlay (e.g., via a displayed user interface element) by performing a selection or other type of action (e.g., by clicking on the element, by performing a voice command or gesture, etc.). For example, the indication of user interaction can comprise user details (e.g., a unique user or account identifier) and details regarding the action (e.g., a selection for a polling question).

At 660, updated streaming media is received. The updated streaming media selected based at least in part on the indication of user interaction (e.g., based on interaction by one user and/or based on aggregate interaction data by a number of users). For example, a server environment can receive results from a polling web overlay and send updated streaming media based on results of the poll (e.g., to display a game trailer that is selected by the most users viewing the streaming media).

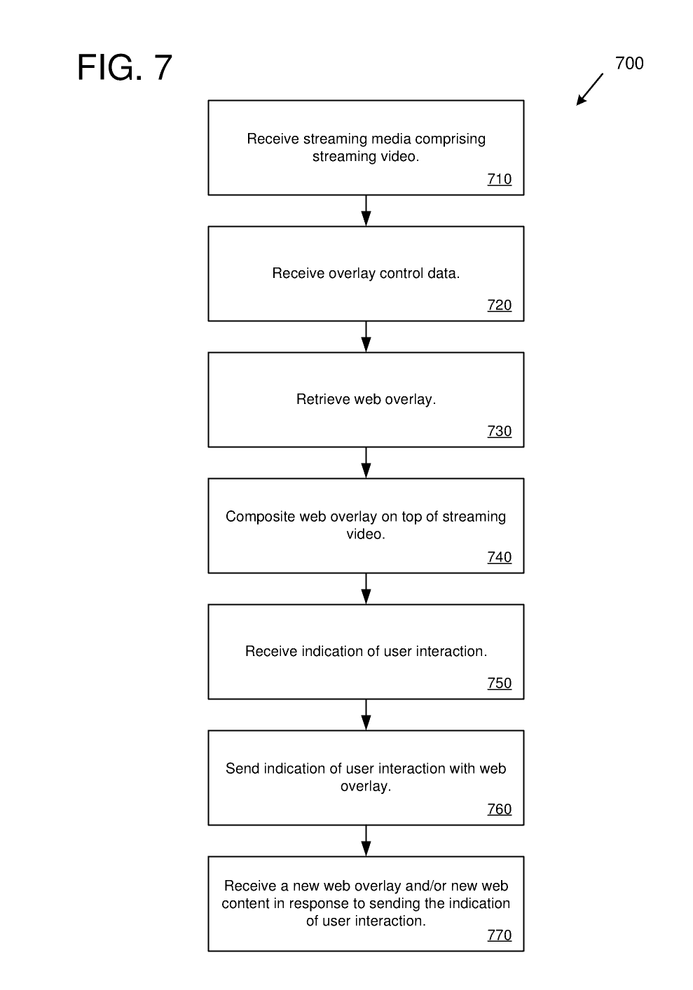

FIG. 7 is a flowchart of an example method 700 supporting two-way interaction with a web overlay. For example, the example method 700 can be performed by a computing device running a media player, such as media player 120.

At 710, streaming media is received. The streaming media comprises streaming video, and can also comprise streaming audio.

At 720, overlay control data is received. The overlay control data comprises timing information for controlling display of a web overlay. The overlay control data can also comprise information describing the web overlay (e.g., a link for obtaining the web overlay).

At 730, the web overlay is received. For example, the web overlay can be obtained via a link within the overlay control data.

At 740, the web overlay is composited on top of the streaming video according to the overlay control data. For example, the timing information can specify a time at which to display the web overlay and a time at which to remove the web overlay from display. The timing information can be used to control other aspects of the web overlay as well, such as transitions (e.g., fade-in and fade-out of the web overlay).

At 750, an indication of user interaction is received (e.g., by receiving a selection of a user interface element, by receiving a voice commend or gesture to make a selection, etc.)

At 760, an indication of the user interaction with the web overlay is sent to a server environment (e.g., to server environment 105).

At 770, a new web overlay and/or new web content is received in response to sending the indication of user interaction. For example, updated web content can be received for displaying in an existing web overlay (e.g., when a user selects a polling question, individual and/or aggregate polling results can be received and displayed within the existing web overlay). As another example, a new web overlay containing new web content can be received and composited for display to replace an existing web overlay (e.g., after answering a first polling question, a new web overlay can be received for presenting a second polling question to the viewers).

### Example Overlay Control Data

In the technologies described herein, overlay control data can be provided in a variety of formats, including JSON or XML. Overlay control components and operations can be provided supporting live compositing of web overlays over streaming video.

Below is an example of overlay control data in the JSON data format.

### Computing Systems

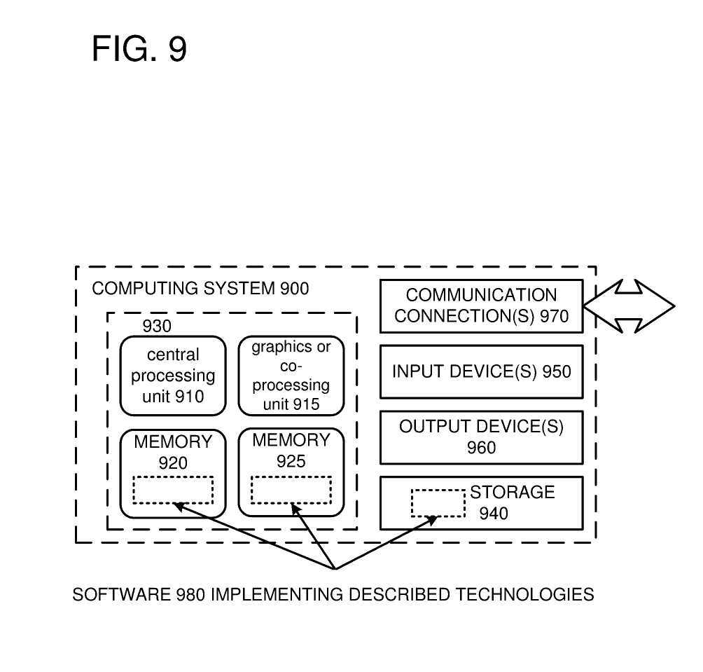

FIG. 9 depicts a generalized example of a suitable computing system 900 in which the described innovations may be implemented. The computing system 900 is not intended to suggest any limitation as to scope of use or functionality, as the innovations may be implemented in diverse general-purpose or special-purpose computing systems.

With reference to FIG. 9, the computing system 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may have additional features. For example, the computing system 900 includes storage 940, one or more input devices 950, one or more output devices 960, and one or more communication connections 970. An interconnection mechanism (not shown) such as a bus, controller, or network interconnects the components of the computing system 900. Typically, operating system software (not shown) provides an operating environment for other software executing in the computing system 900, and coordinates activities of the components of the computing system 900.

The tangible storage 940 may be removable or non-removable, and includes magnetic disks, magnetic tapes or cassettes, CD-ROMs, DVDs, or any other medium which can be used to store information and which can be accessed within the computing system 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing system 900. For video encoding, the input device(s) 950 may be a camera, video card, TV tuner card, or similar device that accepts video input in analog or digital form, or a CD-ROM or CD-RW that reads video samples into the computing system 900. The output device(s) 960 may be a display, printer, speaker, CD-writer, or another device that provides output from the computing system 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 9, computer-readable storage media include memory 920 and 925, and storage 940. The term computer-readable storage media does not include signals and carrier waves. In addition, the term computer-readable storage media does not include communication connections (e.g., 970).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology.

What is claimed is:

1. A computing device comprising:
a processing unit;
a network connection; and
memory;
the computing device configured to perform operations for two-way interaction with a composited web overlay over streaming video, the operations comprising:
receiving, via the network connection, streaming media, the streaming media comprising streaming video;
receiving, via the network connection, overlay control data comprising timing information controlling display of a web overlay;
receiving, via the network connection, the web overlay;
compositing, in real-time, the web overlay on top of the streaming video according to the overlay control data for display to a user as a live interactive web control;
sending, to a server environment, an indication of user interaction with the web overlay; and
in response to sending the indication of user interaction, receiving, from the server environment, updated streaming media, wherein the updated streaming media is selected based at least in part on the indication of user interaction.

2. The computing device of claim 1 wherein the streaming media is live streaming media or on-demand streaming media.

3. The computing device of claim 1 the operations further comprising:
receiving, as the indication of user interaction, a selection by the user of a graphical user interface element displayed within the web overlay of the composited streaming video.

4. The computing device of claim 1 wherein the overlay control data comprises information describing the web overlay, wherein the information describing the web overlay comprises a uniform resource locator (URL) for obtaining web content for the web overlay, the web content comprising one or more of: text content, image content, hypertext markup language (HTML) content, cascading style sheet (CSS) content, or JavaScript content.

5. The computing device of claim 1 wherein the composited streaming video is provided in real-time for live interaction with the user viewing the composited streaming video, the operations further comprising:
in response to sending the indication of user interaction, receiving, from the server environment, updated web content for displaying in the web overlay.

6. The computing device of claim 1 wherein the composited streaming video is provided in real-time for live interaction with the user viewing the composited streaming video, the operations further comprising:
in response to sending the indication of user interaction, receiving, from the server environment, a new web overlay, wherein the new web overlay is composited on top of the streaming video and provided for display to replace the web overlay according to timing information in the overlay control data.

7. The computing device of claim 1 wherein the updated streaming media is selected based on aggregate user interaction data generated by a plurality of users, including the user, viewing the streaming media.

8. The computing device of claim 1 the operations further comprising:
in response to sending the indication of user interaction, receiving, from the server environment, a new web overlay and associated web content, the web content comprising information generated from aggregate user response data related to the streaming media.

9. The computing device of claim 1 the operations further comprising:
in response to sending the indication of user interaction, receiving, from the server environment, a new user-specific web overlay and associated web content, the web content comprising information that is specific to the user viewing the streaming media.

10. The computing device of claim 1 the operations further comprising:
sending, to the server environment, user attributes of the user viewing the streaming media; and
receiving, from the server environment, a new web overlay that is associated with web content selected, from a plurality of available web content, based on the user attributes of the user.

11. The computing device of claim 1 wherein the streaming video is received in an Internet protocol television (IPTV) format, and wherein the streaming video, the web overlay, and the overlay control data received over a hypertext transfer protocol (HTTP) network connection.

12. A method, implemented by a computing device, for two-way interaction with a composited web overlay over streaming video, the method comprising:
receiving streaming media comprising streaming video, wherein the streaming media is live streaming media or on-demand streaming media;
receiving overlay control data in a data format, the overlay control data comprising:
instructions for retrieving web content for display within a web overlay; and
instructions indicating timing control for displaying the web overlay;
retrieving the web overlay according to the overlay control data;
compositing, in real-time, the web overlay on top of the streaming video according to the overlay control data for display to a user as a live interactive web control;
receiving, from the user, an interaction with a user interface element displayed within the web overlay of the composited streaming video;
sending, to a server environment, an indication of the user interaction with the web overlay; and
in response to sending the indication of user interaction, receiving, from the server environment, a new web overlay, wherein the new web overlay is composited on top of the streaming video and provided for display to replace the web overlay according to timing information in the overlay control data.

13. The method of claim 12 wherein the new web overlay displays new web content comprising information generated from aggregate user interaction data, generated from a plurality of users, related to the streaming media.

14. The method of claim 12 wherein the new web overlay is a user-specific new web overlay and associated new web content, the new web content comprising information that is specific to the user viewing the streaming media.

15. The method of claim 12 the operations further comprising:
sending, to the server environment, user attributes of the user viewing the streaming media;
wherein the new web overlay is associated with new web content selected, from a plurality of available web content, based on the user attributes of the user.

16. The method of claim 12 wherein the new web overlay displays new web content comprising:
information generated from aggregate user interaction data obtained from a plurality of other users that are interacting with the streaming media concurrently with the user viewing the streaming media; and
information that is specific to the user viewing the streaming media.

17. The method of claim 12 further comprising:
in response to sending the indication of user interaction, receiving, from the server environment, updated streaming media, wherein the updated streaming media is selected based on aggregate user interaction data generated by a plurality of users, including the user, viewing the streaming media.

18. A computer-readable storage medium storing computer-executable instructions for causing a computing device to perform operations for two-way interaction with a composited web overlay over streaming video, the operations comprising:
receiving streaming media comprising streaming video, wherein the streaming media is live streaming media or on-demand streaming media;
receiving overlay control data in a data format, the overlay control data comprising:
instructions for retrieving web content for display within a web overlay; and
instructions indicating timing control for displaying the web overlay;
retrieving the web overlay according to the overlay control data;
compositing, in real-time, the web overlay on top of the streaming video according to the overlay control data for display to a user as a live interactive web control;
receiving, from the user, an interaction with a user interface element displayed within the web overlay of the composited streaming video;
sending, to a server environment, an indication of the user interaction with the web overlay; and
in response to sending the indication of user interaction, receiving, from the server environment, new web content that is provided for display within the web overlay.

19. The computer-readable storage medium of claim 18 the operations further comprising:
in response to sending the indication of user interaction, receiving, from the server environment, updated streaming media, wherein the updated streaming media is selected based on aggregate user interaction data generated by a plurality of users, including the user, viewing the streaming media.

20. The computer-readable storage medium of claim 18 wherein the new web content comprises:
information generated from aggregate user interaction data obtained from a plurality of other users that are interacting with the streaming media concurrently with the user viewing the streaming media; and
information that is specific to the user viewing the streaming media.
